(19) United States
(12) Patent Application Publication
(10) Pub. No.: US 2006/0245557 A1
(43) Pub. Date: Nov. 2, 2006

(54) Configurable interactive voice response messaging control and monitoring system and method

(75) Inventors: Jon Paden, Austin, TX (US); Bobby Sams, Austin, TX (US); Robert Smith, Cedar Park, TX (US); Scott Newman, Little Elm, TX (US); Troy Eppenbach, Frisco, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/119,547

(22) Filed: May 2, 2005

(51) Int. Cl. H04M 11/00

(52) U.S. Cl. 379/88.16

(57) ABSTRACT

A configurable interactive voice response messaging control and monitoring system (10) includes a user interface (16) enabling a dynamic selection of groups based on one or more among area codes, interactive voice response system locations, or call types, a database (18) containing a status of override messages accessible by the user interface, and an interactive voice response system (14) coupled to the database for playing override messages as dynamically controlled by criteria set in the database. The system can further include a network operating center (NOC) (26) coupled to the database for monitoring the status of override messages. The NOC can also be coupled to an enterprise telecom system (28) enabling monitoring of the status of override messages by one or more call centers (31, 32, 33) coupled to the enterprise telecom system. Note, override messages can also be controlled by responses to API triggers where an outage condition exists.

### BACKGROUND

1. Field of the Invention

The present invention is related to the field of telecommunications, and, more particularly, to the field of dynamic or ambush messaging used with interactive voice response (IVR) systems.

2. Description of the Related Art

Ambush messaging or alternate messaging or intercept messaging (herein after collectively, override or dynamic messaging) involves messaging placed on an IVR system, network prompter or voice recognition unit for example. Such override messages can include, but are not limited to, system outage alerts, available software upgrade alerts, virus alerts, an advisory about a service change requiring some re-configuration by the end user, or any other messaging that is not part of a normal IVR flow. Ambush messaging is commonly used for alerts regarding network outages.

Most if not all providers of any type of telecommunication service where customers contact the provider via an IVR or voice recognition unit (VRU) system have some type of ambush messaging capability. Typical implementations consist of the ability to turn pre-recorded messages on or off via a phone or an internet connection and also the ability to record a message and activate it in the same fashion. Unfortunately, current implementations are typically very limited in their flexibility as they are hard coded or embedded with the specific IVR application using them. Such systems do not take into account all possible variables of who should and should not hear an ambush message. Nor is there any real time visual monitoring interface available as a tool.

### SUMMARY OF THE INVENTION

In a first embodiment of the invention, a configurable interactive voice response messaging control and monitoring system can include a user interface enabling a dynamic selection of groups based on one or more among area codes, interactive voice response system locations, and call types, a database containing a status of override messages accessible by the user interface, and an interactive voice response system coupled to the database for playing override messages as dynamically controlled by criteria set in the database. The system can further include a network operating center (NOC) coupled to the database for monitoring the status of override messages. The NOC can also be coupled to the user interface and provide feedback to the user interface. The NOC can also be coupled to an enterprise telecom system enabling monitoring of the status of override messages by one or more call centers coupled to the enterprise telecom system. Note, the override messages can be controlled by at least one among an area code, a grouping of area codes, or a telephone number. Override message can also be controlled by responses to API triggers where an outage condition exists. The user interface can provide at least one among a geographical view and an IVR tree view to serve as a visual aid in controlling activation and deactivation of override messages. The user interface in this regard can be a geographically selectable graphical user interface enabling a user to view at least a status of an override message based on geographic location. The interactive voice response system can further include an IVR user interface that can be controlled by a set of criteria specified in the database.

In a second embodiment in accordance with the invention, a method of controlling and monitoring override messages on a communication network having a interactive voice response system can include the steps of creating a dynamically selected group based on one or more among area codes, interactive voice response system locations, or call types, generating and storing an override message and an associated override message status in a database accessible by a user interface, and presenting the override message only to callers of members of the dynamically selected group in response to a call into an interactive voice response system coupled to the database as dynamically controlled by criteria set in the database. Monitoring the status of override messages can be done remotely on the communication network in real-time and can be done by one among a network operating center, an enterprise telecom system coupled to the network operating center, and a remote authorized user coupled to the network operating center. In this regard, real time monitoring of the status of override messages can be done by one or more call centers coupled to the enterprise telecom system. Note, the step of creating the dynamically selected group can be done by selecting at least one among an area code, a grouping of area codes, a telephone number, a group of phone numbers with a predetermined prefix, a call type selected among a phone number, an email address or group of email addresses, an IP address or group of IP addresses, a DSL service line, a cable service line, or a domain name or a group of domain names. Also note that monitoring can be done by viewing a geographically selectable graphical user interface.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a communications network including a system according to one embodiment of the present invention.

FIG. 2 is a schematic diagram of graphical user interface that can be generated by the system in FIG. 1.

FIG. 3 is a schematic diagram of another graphical user interface that can be generated by the system in FIG. 1.

FIG. 4 is a flowchart of a method according to another embodiment of the present invention.

### DETAILED DESCRIPTION OF THE INVENTION

The embodiments herein disclose a system and related methods for controlling and monitoring override or ambush messages on a communication network having a interactive voice response system. The system can include a user interface that enables the dynamic selection of groups that aid in targeting the override messages on a geographic basis (using for example, area codes), on a call type basis, or by other customized criteria.

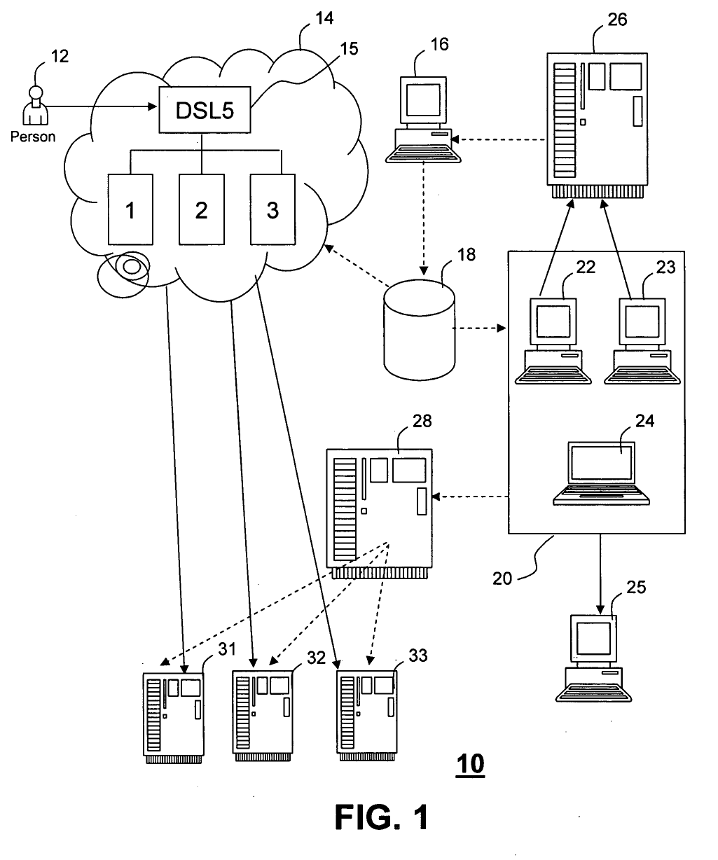

Referring to FIG. 1, a schematic diagram illustrating elements of a communication system 10 according to an embodiment of the present invention is shown that can selectively target callers or groups of callers 12 into an IVR system 15 subject to an override or ambush message. The IVR system 15 can be part of a communication system or platform 14. The targeting can be done by customer, geographic area, call type, or other criteria as specified by a current active override or ambush database 18. In one configuration, the system 10 can include an ambush activation user interface 16 in the form of a graphical user interface or GUI that provides geographic and IVR tree views for visual aid in activation (or deactivation) of ambush messages specific to a region or call type. The user interface 16 can reside within a network reliability center (NRC) or network operation center (NOC) 26 or can be remotely connected using appropriate precautions for authorized use. The user interface 16 can be coupled to the current active ambush database 18 which stores data inserted from the GUI 16 and is readable externally by the IVR platform 14 and other systems such as read only monitoring interface components 20 that can include desktop computers 22 or 23 and laptop computer 24 that are authorized to perform NOC monitoring. One application on desktop computer 22 can be dedicated to monitoring the active ambush messaging in a geographic view while the other desktop computer 23 can be dedicated to monitoring the active ambush messaging based on call type. Other systems can include read only monitoring interfaces such as remote cite 25. The remote cites can be coupled to the NRC or NOC 26 which can also include additional read only monitoring interface components.

The system 10 can further include an IVR user interface component 15 that compares call data such as automatic number identification (ANI), user ID, or other data to data in the current active database 18. The IVR user interface component 15 can also provide the targeted messaging to the caller 12 based on criteria specified by the NRC or NOC 26 with the capability for additional messaging upon caller selection. The system 10 can also include an enterprise telecommunications and call center management component (or enterprise data center) 28 that can receive immediate notification of override or ambush activation and can advise impacted call centers 31, 32, or 33.

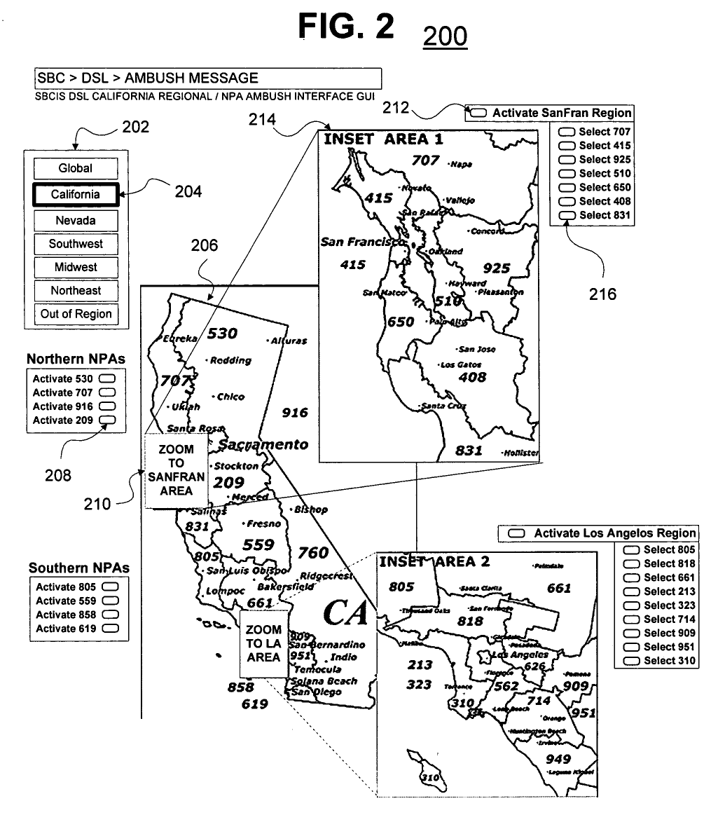

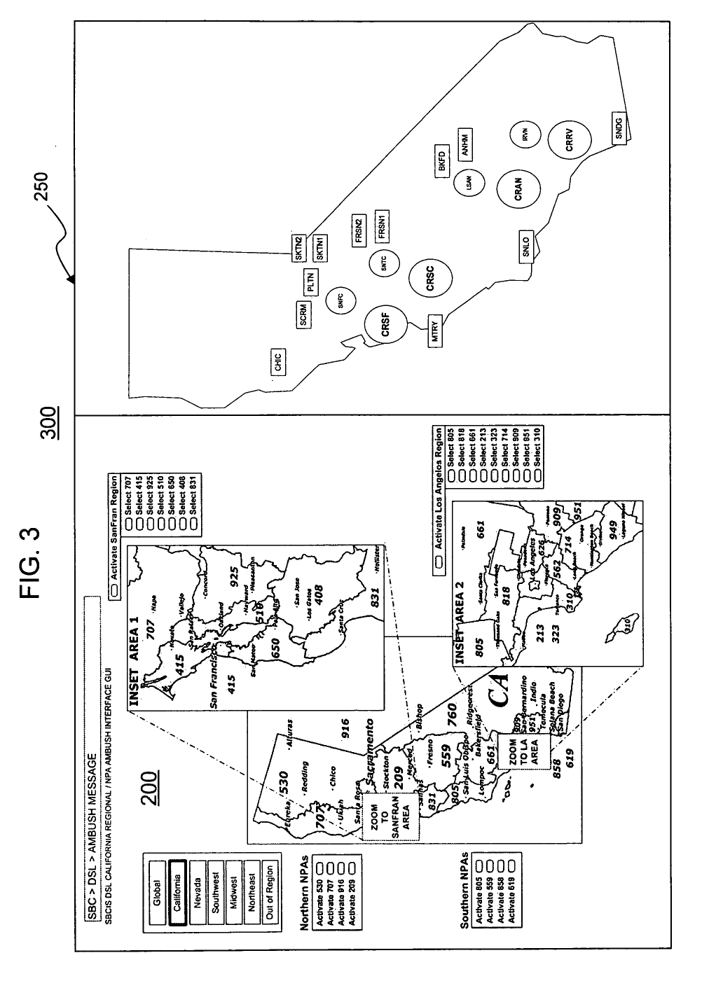

More specifically, the particular company's NOC (26) or other authorized personnel can utilize the user interface 16 to activate or deactivate an ambush message. Such message can be pre-recorded or recorded in real time. As mentioned above, the user interface 16 can be a graphical user interface 200 as illustrated in FIG. 2 which can be web accessible and capable of displaying a message to be activated, a region (210 or 212) to be activated, the duration of a message, the IVR location of a message, or any other variable specified by the business. Such user interface enables dynamic selection of groups based any number of criteria such as area codes, interactive voice response system locations, and call types. With geographic based criteria, selection of targeted areas can be drilled down to specific area codes, geographic areas correlating to pre-fixes within phone numbers, or physical streets or street addresses if desired. Such an arrangement can be useful particularly when grouping and activating or deactivating states and area codes within states and also specifying groups of area codes to form regions or sub-regions that can also be selectively activated or deactivated. In yet another variant as illustrated by FIG. 3, the GUI 200 can be combined with another GUI 250 based on population to create a split screen interface 300 that can provide addition information.

The database 16 containing the status of override messages and other data can be resident with the IVR platform 14, the enterprise data center 28, the NOC 26 or even hosted on a completely external platform. Note, the user interface 16 can have read and write privileges, whereas all other components in the system would generally just have read only access. The parameters specified using the user interface 16 are pushed into the database 16 in real time and in turn read by the IVR component 15. As noted above, such parameters can drive the IVR to specific messages based on a caller's area code (NPA), a caller's predetermined phone number prefix (NPA-NXX), or a caller's full telephone number. Other parameters can be based on a call type, a call time, or a specific response to an individual. A specific message can be made in response to certain API triggers where an “outage” condition can exist.

Note, monitoring interfaces (22, 23, 24, or 25) that are read only can display multiple view of currently active ambush messages similar to the user interface 16 used to activate such messages. Different alert levels, severities, or types (e.g., email as opposed to connectivity, or “hard outage” as opposed to “unconfirmed problem reports” under investigation) can be color coded for better user readability. Further note, where overlapping ambush messages apply, a screen-cycling interface can be used. A user can select any or all active views and specify cycle duration. Additionally, a layered or multi-screen view can be selected.

The call flow of the IVR component 15 can be iterated in a limitless number of ways. Using the user interface 16 and database 18, any normal IVR state, script message or other routine can be suppressed, replaced, prefaced, or supplemented based on the criteria specified in the active ambush database 18.

By using the read only monitoring interfaces (22, 23, 24, or 25), any of the entities with access to such systems can relay the earliest possible warning to those without. In the embodiment shown, the information is relayed through a central enterprise data center 28 or call center management entity. Such an entity is a practical conduit, as the information relayed should be centrally coordinated and properly assessed, especially in an environment with a multiplicity of on/offshore call centers, where some, none, or all may be impacted.

As noted above, the system 10 can further include the network operating center (NOC) 26 coupled to the database 18 for monitoring the status of override messages. The NOC 26 can also be coupled to the user interface 16 and provide feedback to the user interface 16. The NOC 26 an also be coupled to the enterprise telecom system 28 enabling monitoring of the status of override messages by one or more call centers (31, 32 or 33) coupled to the enterprise telecom system 28. Note, the override messages can be controlled by at least one among an area code, a grouping of area codes, or a telephone number for example. Of course, these are just a few among many other criteria that can be used to target messages. For example, if internet traffic is subject to an override message, then such targeting can be based on a registrant's domain name (e.g., xxxxx.com or yyyyy.com) or on a top level domain (e.g., xxxxx.com or xxxxx.net) or any other differentiating characteristic. Override messages can also be controlled by responses to API triggers where an outage condition exists. The user interface 16 can also provide at least one among a geographical view and an IVR tree view to serve as a visual aid in controlling activation and deactivation of override messages. The user interface 16 in this regard can be a geographically selectable graphical user interface enabling a user to view at least a status of an override message based on geographic location. Of course, the user interface 16 can help activate and deactivate selected groups and traverse through trees or nested geographic maps as is apparent with respect to FIGS. 2 and 3. The interactive voice response system 15 can also further include an IVR user interface that can be controlled by a set of criteria specified in the database.

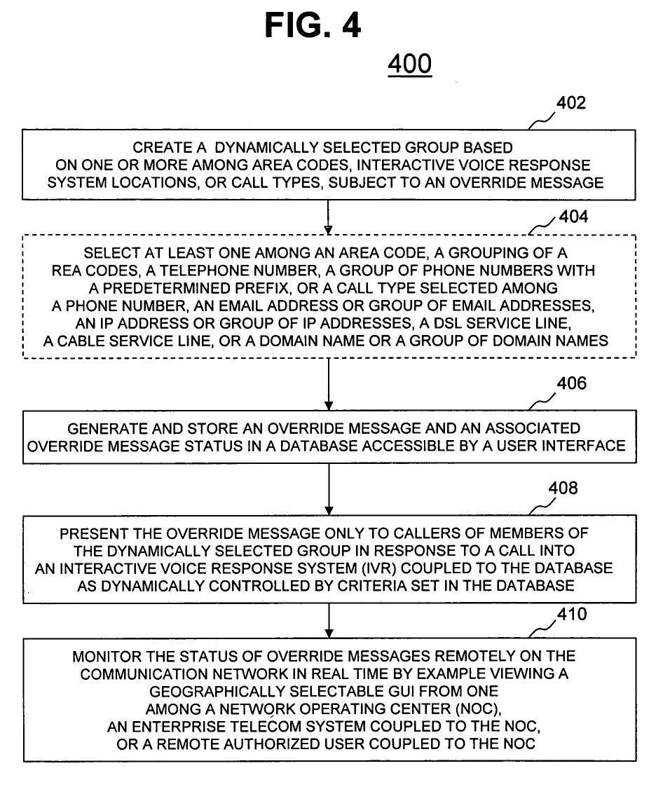

Referring to FIG. 4, a flow chart illustrating a method 400 of controlling and monitoring override messages on a communication network having an IVR system can include the step 402 of creating a dynamically selected group based on one or more among area codes, interactive voice response system locations, or call types, the step 406 of generating and storing an override message and an associated override message status in a database accessible by a user interface, and the step 408 of presenting the override message only to callers of members of the dynamically selected group in response to a call into an interactive voice response system coupled to the database as dynamically controlled by criteria set in the database. Monitoring the status of override messages can be done remotely on the communication network in real-time and can be done by one among a network operating center, an enterprise telecom system coupled to the network operating center, and a remote authorized user coupled to the network operating center as found at step 410. In this regard, real time monitoring of the status of override messages can be done by one or more call centers coupled to the enterprise telecom system. Note, the step of creating the dynamically selected group can optionally be done by selecting at least one among an area code, a grouping of area codes, a telephone number, a group of phone numbers with a predetermined prefix, a call type selected among a phone number, an email address or group of email addresses, an IP address or group of IP addresses, a DSL service line, a cable service line, or a domain name or a group of domain names as noted at step 404. Also note that monitoring can be done by viewing a geographically selectable graphical user interface.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. A configurable interactive voice response messaging control and monitoring system, the system comprising:
a user interface enabling a dynamic selection of groups based on one or more among area codes, interactive voice response system locations, and call types, subject to an override message;
a database containing a status of override messages accessible by the user interface; and
an interactive voice response system coupled to the database for playing override messages as dynamically controlled by criteria set in the database.

2. The system of claim 1, wherein the system further comprises a network operating center coupled to the database for monitoring the status of override messages.

3. The system of claim 2, wherein the network operating center is further coupled to the user interface and provides feedback to the user interface.

4. The system of claim 2, wherein the network operating system is further coupled to an enterprise telecom system enabling monitoring of the status of override messages by one or more call centers coupled to the enterprise telecom system.

5. The system of claim 1, wherein override messages are controlled by at least one among an area code, a grouping of area codes, and a telephone number.

6. The system of claim 1, wherein override messages are further controlled by responses to API triggers where an outage condition exists.

7. The system of claim 1, wherein the user interface provides at least one among a geographical view and an IVR tree view to serve as a visual aid in controlling activation and deactivation of override messages.

8. The system of claim 1, wherein the user interface is a geographically selectable graphical user interface enabling a user to view at least a status of an override message based on geographic location.

9. The system of claim 1, wherein the interactive voice response system further comprises an IVR user interface that can be controlled by a set of criteria specified in the database.

10. A method of controlling and monitoring override messages on a communication network having a interactive voice response system, comprising the steps of:
creating a dynamically selected group based on one or more among area codes, interactive voice response system locations, and call types, subject to an override message;
generating and storing an override message and an associated override message status in a database accessible by a user interface; and
presenting the override message only to callers of members of the dynamically selected group in response to a call into an interactive voice response system coupled to the database as dynamically controlled by criteria set in the database.

11. The method of claim 10, wherein the method further comprises the step of monitoring the status of override messages remotely on the communication network in real time.

12. The method of claim 11, wherein the step of monitoring is done by one among a network operating center, an enterprise telecom system coupled to the network operating center, and a remote authorized user coupled to the network operating center enabling the monitoring in real time of the status of override messages.

13. The method of claim 11, wherein the step of monitoring is done by one among a network operating center and an enterprise telecom system coupled to the network operating center, enabling the monitoring in real time of the status of override messages by one or more call centers coupled to the enterprise telecom system

14. The method of claim 11, wherein the step of creating the dynamically selected group is done by selecting at least one among an area code, a grouping of area codes, a telephone number, a group of phone numbers with a predetermined prefix, a call type selected among a phone number, an email address or group of email addresses, an IP address or group of IP addresses, a DSL service line, a cable service line, and a domain name or a group of domain names.

15. The method of claim 11, wherein the step of monitoring comprises the step of viewing a geographically selectable graphical user interface.

16. A computer readable storage medium, the storage medium comprising computer instructions for:
creating a dynamically selected group based on one or more among area codes, interactive voice response system locations, and call types, subject to an override message; and
generating and storing an override message and an associated override message status in a database accessible by a user interface that are only presented callers of members of the dynamically selected group in response to a call into an interactive voice response system coupled to the database as dynamically controlled by criteria set in the database.

17. The storage medium of claim 16, wherein the storage medium further comprises computer instructions for monitoring the status of override messages remotely on the communication network in real time.

18. The storage medium of claim 17, wherein the storage medium is further programmed to perform the step of monitoring by using one among a network operating center, an enterprise telecom system coupled to the network operating center, and a remote authorized user coupled to the network operating center enabling the monitoring in real time of the status of override messages.

19. The storage medium of claim 16, wherein the storage medium is further programmed to create the dynamically selected group by selecting at least one among an area code, a grouping of area codes, a telephone number, a group of phone numbers with a predetermined prefix, a call type selected among a phone number, an email address or group of email addresses, an IP address or group of IP addresses, a DSL service line, a cable service line, and a domain name or a group of domain names.

20. The storage medium of claim 17, wherein the storage medium is further programmed to monitor by viewing a geographically selectable graphical user interface.
